(19) United States
(12) Patent Application Publication
(10) Pub. No.: US 2014/0289649 A1
(43) Pub. Date: Sep. 25, 2014

(54) Cooperative 3D Work Station

(71) Applicant: Leonhard Vogelmeier, Dachau (DE)

(72) Inventor: Leonhard Vogelmeier, Dachau (DE)

(73) Assignee: EADS Deutschland GmbH, Ottobrunn (DE)

(21) Appl. No.: 14/343,470

(22) PCT Filed: Sep. 4, 2012
(86) PCT No.: PCT/DE2012/000882

§ 371 Date: May 8, 2014

(30) Foreign Application Priority Data
Sep. 8, 2011 (DE) 10 2011 112 617.5

(51) Int. Cl. G06T 19/00

(52) U.S. Cl. CPC G06T 19/00; G06T 2219/024
USPC 715/757

(57) ABSTRACT

A display apparatus for depicting a three-dimensional scenario includes a first and a second projection device, and a holographic display device having a first and a second holographic unit. A depiction apparatus includes a number of the display apparatuses for the depiction and cooperative processing of a three-dimensional scenario by a number of users that each observe the three-dimensional scenario from an individually determinable perspective.

### FIELD OF THE INVENTION

Exemplary embodiments of the invention relate to the depiction of and the interaction with a three-dimensional scenario. In particular, the invention relates to a display apparatus for depicting a three-dimensional scenario, a depiction apparatus for a three-dimensional scenario for the cooperative processing of the three-dimensional scenario by a plurality of users, the use of a depiction apparatus for a three-dimensional scenario for the cooperative processing of the three-dimensional scenario by a plurality of users for the cooperative monitoring of airspaces, and a method for depicting a three-dimensional scenario and a method for the cooperative processing of a three-dimensional scenario.

### BACKGROUND OF THE INVENTION

Stereoscopic systems with individual image generation for one or more users are known. With these stereoscopic systems, individual images for the left eye and the right eye of an observer are respectively displayed on a screen. In doing so, it must also be ensured that the respective eye is only able to detect the image intended for this eye in each case, so that the observer has the impression of spatial observation as a result of the different images perceived by the eyes. This separation of the images for the respective eyes of the observer can take place, for example, by the use of prisms which refract the light so that the eyes observe different images.

In addition, it is known to use glasses with differently polarized lenses for the user or observer. Accordingly, two different images with differently polarized light are displayed on a display surface, wherein each lens only allows the correspondingly polarized light to pass through to the eye of the observer. In this way, the impression of a three-dimensional scenario can be invoked for the observer by means of different images that are presented to his two eyes.

These two basic possible ways of building up a system for depicting a three-dimensional scenario can basically also be chosen for a plurality of observers. In doing so, it can easily be made possible for a second observer or every further observer to view the three-dimensional scenario, as long as all observers view the same scenario.

If, however, a second observer is to view a different scenario from the first observer, then, in addition to the two images for the first observer, a display must also depict two further images for the second observer. In doing so, not only must it be ensured that each eye views the image intended for this eye, and only this image, but also that a discrimination of the images with regard to the observers has to be achieved.

The limit of the known stereoscopic systems is shown, particularly when a plurality of observers views a three-dimensional scenario, in that in each case a display has to depict two further images for each further observer. However, every further image depicted on a display reduces the quality of the other images, as the depiction capacity, for example the resolution, of the display has to be divided between a plurality of images.

### SUMMARY OF THE INVENTION

Exemplary embodiments of the present invention provide a device for depicting a three-dimensional scenario which enables a cooperative processing of the three-dimensional scenario by a plurality of users.

In particular, exemplary embodiments of the present invention are directed to a device for depicting a three-dimensional scenario that enables the device to be scaled for a plurality of users or observers such that a simultaneous and cooperative interaction of the plurality of observers with the depicted three-dimensional scenario can take place without loss of quality and yet every observer has an individual view of the three-dimensional scenario.

A display apparatus for depicting a three-dimensional scenario, a depiction apparatus for a three-dimensional scenario for the cooperative processing of the three-dimensional scenario by a plurality of users, and a use of a depiction apparatus for the cooperative monitoring of airspaces, and a method for depicting and a method for the cooperative processing of a three-dimensional scenario are provided.

Many of the characteristics described below with regard to the display apparatus and the depiction apparatus can also be implemented as method steps and vice versa.

According to a first aspect of the invention, a display apparatus for depicting a three-dimensional scenario has a first projection device and a second projection device and a holographic display device having a first holographic unit and a second holographic unit. Here, the first projection device and the second projection device are designed to cast a first image and a second image respectively onto the holographic display device. The first holographic unit and the second holographic unit are designed to spread the first image and the second image respectively such that a first eye of the user perceives the first image and a second eye of the user perceives the second image such that the user has the impression of a three-dimensional scenario.

The holographic display device can be a display disk, for example, and the first and the second holographic unit can be a hologram, for example. The first projection device and the second projection device can be laser projectors, for example.

The holograms can be adjusted, for example, such that they each only admit the light of one of the two projection devices and guide or spread it in a second direction such that the corresponding image can only be seen from a certain viewing angle. In other words, this means that each hologram is designed to only admit light from a specified angle of incidence and to emit this light at a specified angle of reflection.

Accordingly, the first projection device is arranged to project light onto the first hologram such that it impinges upon the first hologram at the appropriate angle of incidence. This applies in a similar manner for the arrangement of the second projection device and the second hologram.

At the same time, the first holographic unit can be designed to guide the light of the first projection device into a first half space, and the second holographic unit can be designed to guide the light of the second projection unit into a second half space. An observer of the holographic display device therefore has the impression of a three-dimensional scenario, wherein a first eye of the observer perceives the first image and a second eye of the observer perceives the second image. Here, the first eye is in the first half space and the second eye in the second half space.

According to an embodiment of the invention, the display apparatus further has a detector unit and an actuator. Here, the detector unit is designed to determine a position of the first eye and the second eye of the user. The actuator is designed to move the holographic display device such that a viewing direction of the user meets the display device at right angles in a sagittal plane of the display device.

As the user has the impression of a three-dimensional scenario because each eye of the user sees its own image, it is necessary in each case for an eye of the user to be in the half space associated with this eye.

Naturally, the viewing direction of the user in the sagittal plane can also meet the display device at any other angle as long as this angle corresponds to the radiation direction of the images by the holograms such that each eye can perceive the image assigned to it.

Here, a half space designates a spatial region on the viewing side of the holographic display device in which only the image of the first projection device or the image of the second projection device can be perceived by the eye in the respective half space.

At the same time, the arrangement of the first half space and of the second half space is specified by the arrangement of the user's eyes, whereby the first half space and the second half space are offset horizontally with respect to one another such that one eye of the user is in the first half space and one is in the second half space.

The first holographic unit and the second holographic unit can be designed such that a positioning of the first half space and of the second half space is adjusted depending on an interpupillary distance between the first eye and the second eye of the user and/or depending on a distance of the user from the holographic display device.

Particularly in the case of a horizontal or lateral movement of the user with respect to the holographic display device, it can come about that at least one eye moves out of the half space intended for this eye and the impression of a three-dimensional scenario is therefore disrupted.

In other words, this means that the first eye and the second eye of the user perceive the first image and the second image respectively individually because the first half space and the second half space are offset horizontally to the extent defined by the horizontal interpupillary distance of the user. On the other hand, a change in the viewing position of the user in the vertical direction does not cause one eye to move into the half space of the other eye.

A vertical movement of the user can cause the distance from the user's eyes to the holographic display device to change. This may lead to the perception of the first image and/or of the second image being disrupted. Accordingly, the display device can also be moved such that the distance of the user's eyes from the display device remains substantially constant. In other words, this means that the display device can be moved in a direction towards the user and away from the user.

However, the first holographic unit or the second holographic unit can also be designed such that adjustments to the holographic units can be made in such a way that the holographic units adapt themselves to vertical movements of the user, and a perception of the first image and of the second image is enabled in spite of a varying distance of the user's eyes from the display device.

To improve the ease of use of the display apparatus, the holographic display device can be rotated by means of the actuator about a vertical axis of the display device such that the user's eyes are always in the half space assigned to the respective eye regardless of his horizontal positioning.

The sagittal plane of the display device is spanned by a viewing direction of the user towards the display device and a horizontal axis of the display device. A vertical movement of the user's eyes corresponds to a change in the inclination of the sagittal plane with respect to the display device in that the sagittal plane rotates about the horizontal axis of the display device.

A movement of the user's eyes in a horizontal direction can cause one eye to leave the half space assigned thereto and therefore the impression of a three-dimensional scenario is disrupted. In order to maintain the three-dimensional impression for the user, the holographic display device must now be rotated about its vertical axis such that the extension of the first half space and of the second half space is brought into alignment with the first eye and the second eye of the user.

In other words, this means that the angle between the viewing direction of the user towards the display device and the display device remains constant. This angle can be any angle, the decisive factor being that it remains constant for a horizontal movement of the user's eyes. Preferably, the viewing angle in the sagittal plane forms a right angle with the display device, i.e. an angle of 90 degrees.

According to a further embodiment of the invention, the detector unit has at least one camera.

Here, the camera can be designed to determine the position of at least one eye of the user such that the actuator is instructed to move the holographic display device, i.e. to rotate it about its horizontal axis, into such a position that the user perceives the first image of the holographic display device with the first eye and the second image with the second eye.

However, the camera can also be designed to follow a clearly identifiable object which, for example, is located next to one of the user's eyes. This clearly identifiable object can, for example, be a sticker with a visual coding feature, for example a barcode.

According to a further embodiment, the holographic display device is designed to depict a pointer element. Here, the user can interact with the three-dimensional scenario in that a connecting line is formed from the first eye or the second eye of the user via the pointer element to the three-dimensional scenario. However, the connecting line can also be formed as the mean value between the two connecting lines from the left eye and right eye respectively via the pointer element to the three-dimensional scenario.

The element in the three-dimensional scenario that has been selected can be determined by means of the calculated connecting line from one eye of the user via the pointer element.

According to a further embodiment of the invention, the pointer element is placed on the holographic display device by the user touching the display device with a finger.

For example, the holographic display device can have a touch-sensitive layer which is designed to determine the point at which the user's finger touches the display device.

The position of a finger on the holographic display device can also be determined using other technologies for touch-sensitive scanning devices, such as Frustrated Total Internal Reflection (FTIR) for example.

According to a further embodiment of the invention, the pointer element is placed on the holographic display device by the detector unit detecting a position of the user's finger.

Here, the detector unit can basically determine the position of the finger in a similar way to detecting the position of the eye, which was described in detail above.

The detector unit can have a multiplicity of detector elements, of which a first group of a plurality of detector elements can be designed for detecting the position of the user's eyes, and a second group of a plurality of detector elements for detecting the position of the user's finger.

Furthermore, the pointer element can be positioned on the display device by means of an input device, such as a so-called computer mouse for example, or a trackball or by means of a keyboard with control arrows as well as any other input devices.

According to a further embodiment of the invention, the display apparatus has a two-dimensional display element designed to provide the user with information in graphical and written form.

The information to be displayed on the two-dimensional display element can be any information that cannot or does not have to be displayed in the three-dimensional scenario.

If, for example, the three-dimensional scenario is an airspace to be monitored with aircraft located therein, information relating to a selected aircraft, such as for example speed, altitude, weather data or other data, can be displayed on the two-dimensional display element.

The two-dimensional display element can be touch-sensitive.

The two-dimensional display element therefore enables an operation to be provided similar to the interaction with the three-dimensional scenario.

According to a further aspect of the invention, a depiction apparatus for a three-dimensional scenario for the cooperative processing of the three-dimensional scenario by a plurality of users that has a multiplicity of display apparatuses as described above and in the following, and wherein, in each case, at least one display apparatus is assigned to a user, is specified.

The depiction apparatus therefore enables the joint and cooperative processing of a scenario by a plurality of users. In doing so, the display apparatuses can be arranged spatially separately or adjoining.

For example, a multiplicity of display apparatuses can be arranged next to one another at a workstation, for example a table, and thus, as well as the joint interaction of the users with the three-dimensional scenario, also enable direct communication of the users with one another.

However, the display apparatuses can also be arranged spatially separately from one another and still enable the joint cooperative processing of a three-dimensional scenario. Here, the display apparatuses can be arranged in different rooms, in different buildings and be spatially separated from one another in any other way. It must only be guaranteed that all display apparatuses have a connection to a central computer system that is responsible for depicting the three-dimensional scenario on the display apparatuses.

However, every display apparatus can, of course, also have a decentralized computer device designed to control the image projection of the first projection device and the second projection device. At the same time, the decentralized computer device can be connected to the central computer system, wherein the central computer system merely carries out the control and coordination of a plurality of decentralized computer devices.

The design of the display apparatuses according to the invention enables the number of users to be scaled at will. For example, the depiction apparatus can be designed for four, eight, twelve or any other number of users, wherein one parameter for defining the number of users can be the complexity and the extent of the three-dimensional scenario to be monitored.

Here, a central computer system controls the display apparatuses such that every user has the impression of a three-dimensional scenario.

Here, the depiction apparatus according to the invention can be used, for example, for the cooperative mission planning of land, water and air vehicles, a joint mission implementation of a plurality of unmanned land, water and air vehicles by the respective vehicle operators, the cooperative monitoring of airspaces or land borders or even the monitoring of events with a mass audience, for example in football or concert stadiums.

Depending on the personnel requirement for the task to be fulfilled, a depiction apparatus according to the invention can be extended such that each user is provided with a display apparatus or a plurality of display apparatuses. Here, the central computer system controls the displays or display details distributed between the individual display apparatuses in such a way that the users process the three-dimensional scenario jointly and cooperatively.

A depiction apparatus as described above and in the following can, of course, also be used for practice and evaluation purposes.

According to an embodiment of the invention, every user sees the three-dimensional scenario from a real perspective. Here, the real perspective is a viewing perspective of the user of the three-dimensional scenario which corresponds to a position of the user at the depiction apparatus.

In the case of airspace monitoring by, for example, four users, the real perspective of the three-dimensional scenario, i.e. the airspace to be monitored, is the viewing perspective that the users would have if they were positioned with respect to the monitoring airspace in the same way as they are positioned with respect to the three-dimensional scenario of the airspace.

In other words, this means that, for example, one of four users distributed uniformly around the depiction apparatus views the three-dimensional scenario of the airspace to be monitored from an easterly direction, a second user from a southerly direction, a third user from a westerly direction and a fourth user from a northerly direction.

According to a further embodiment of the invention, every user sees the three-dimensional scenario from a cloned perspective.

Here, the cloned perspective is a specified viewing perspective of the user of the three-dimensional scenario. In particular, all or also only a specifiable portion of the users can view the three-dimensional scenario from the same viewing perspective.

For example, in the event of a large amount of air traffic, a user can be supported in the area to be monitored by him by a second user in that both users have the same perspective of the three-dimensional scenario reproduced on their display apparatus.

According to a further embodiment of the invention, every user sees the three-dimensional scenario from an individual perspective.

Here, the individual perspective is a viewing perspective of the three-dimensional scenario that can be set up by every user at will. In other words, this means that a user can set up a perspective as if he were moving freely in the depicted space.

In the same way that the user can change a perspective of the three-dimensional scenario, the user can select and enlarge an area of the three-dimensional scenario, for example to obtain more detail of the depiction.

According to a further embodiment of the invention, every user is assigned a second display apparatus that is designed to display a three-dimensional representation of a spatially remote communication partner.

Particularly in conjunction with spatially distributed display apparatuses, it is also possible to depict a user of a remote display device.

According to a further aspect of the invention, the depiction apparatus is used for the cooperative monitoring of airspaces as described above and in the following.

According to a further aspect of the invention, a method for depicting a three-dimensional scenario is specified.

Here, in one step, a first image and a second image are projected onto one holographic display device of a multiplicity of holographic display devices such that an observer of the three-dimensional display apparatus has the impression of a three-dimensional scenario, wherein each holographic display device depicts the three-dimensional overall scenario from a certain viewing perspective.

In a further step, an eye position of the observer is detected.

In a further step, the holographic display apparatus is rotated about a vertical axis such that a view direction of the observer falls on the holographic display apparatus at a specified angle in a sagittal plane of the display device.

According to a further aspect of the invention, a method for the cooperative processing of a three-dimensional scenario is specified.

In one step, an eye position of the observer of the three-dimensional overall scenario is detected.

In a further step, a reference point on the holographic display device is defined.

In a further step, a connecting line from the eye position via the reference point to the three-dimensional overall scenario is calculated.

An object sighted by the observer in the three-dimensional overall scenario is then determined.

### BRIEF DESCRIPTION OF THE FIGURES

Exemplary embodiments of the invention are described below with reference to the figures.

FIG. 1 shows a plan view of a display apparatus according to an exemplary embodiment of the invention.

FIG. 2 shows a plan view of a display apparatus according to a further exemplary embodiment of the invention.

FIG. 3 shows an isometric illustration of a holographic display device according to an exemplary embodiment of the invention.

FIG. 4 shows an isometric illustration of a display apparatus according to a further exemplary embodiment of the invention.

FIG. 5 shows a side view of a display apparatus according to a further exemplary embodiment of the invention.

FIG. 6 shows a plan view of a depiction apparatus for a three-dimensional scenario for cooperative processing by a plurality of users according to an exemplary embodiment of the invention.

FIG. 7 shows a schematic view of a method for the depiction and cooperative processing of a three-dimensional overall scenario.

### DETAILED DESCRIPTION OF EXEMPLARY EMBODIMENTS

The illustrations in the figures are schematic and not to scale.

Where the same reference numbers are used in the following description of the figures, these relate to the same or similar elements.

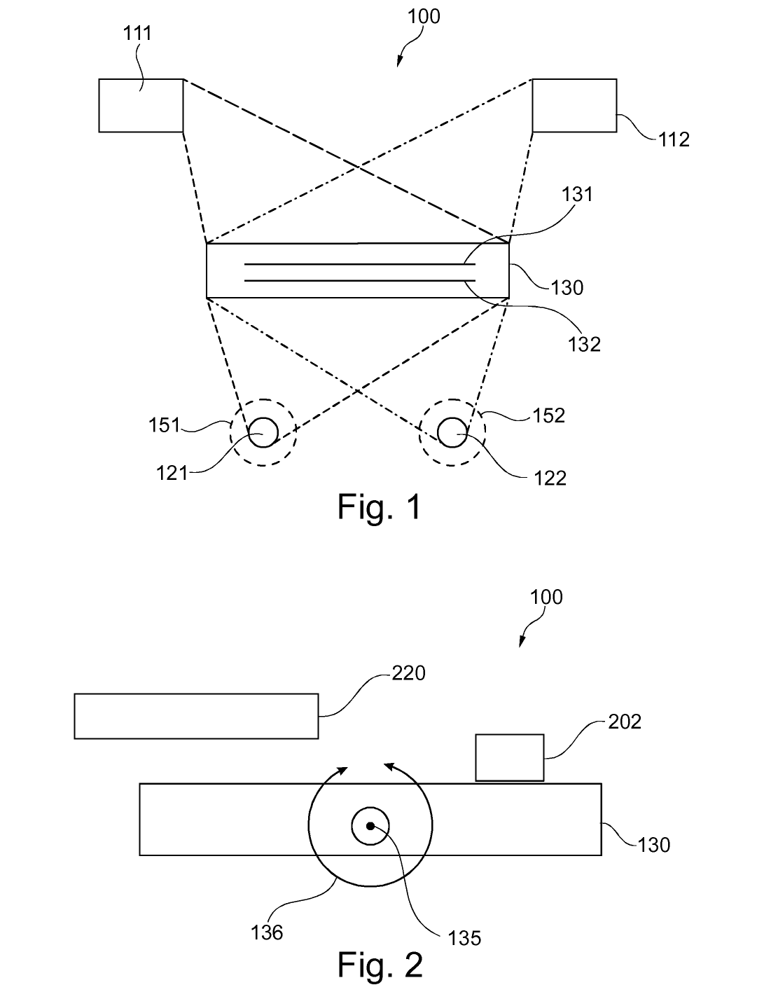

FIG. 1 shows a display apparatus 100 according to an exemplary embodiment of the invention. The display apparatus has a first projection device 111 and a second projection device 112 and a holographic display device 130 having a first holographic unit 131 and a second holographic unit 132.

The first projection device 111 is designed to project an image on the first holographic element 131, wherein the image of the first projection device is guided in the direction of a first eye 121 of a user, and the image of the second projection device 112 is guided by means of the second holographic unit 132 in the direction of a second eye 122 of the user.

As a result of the different images which are perceived by the first eye and the second eye, the user has the impression of a three-dimensional scenario.

Furthermore, FIG. 1 shows a first half space 151 and a second half space 152 in which the first eye and the second eye respectively can be located without the impression of a three-dimensional scenario being disrupted. This impression is only disrupted when the first eye or the second eye leave the first half space or the second half space respectively. Furthermore, the first half space and the second half space are limited in that a distance of the user's eyes from the display apparatus changes when the user moves vertically, which can likewise disrupt the perception of the first image and/or the second image. In order to counteract this effect, the display apparatus is moved towards or away from the user such that a change in distance of the eyes from the display device is compensated for.

FIG. 2 shows a display apparatus 100 according to a further exemplary embodiment of the invention. The display apparatus 100 has a holographic display device 130, an actuator 202 and a detector unit 220.

The detector unit 220 is designed to detect a position of the user of the display apparatus. In order to guarantee that the user's eyes perceive different images so that the user has the impression of a three-dimensional scenario, it may be necessary to rotate the holographic display device 130 about a vertical axis 135 along the direction arrow 136 depending on the position of the user relative to the holographic display device 130 so that each eye of the user can perceive the image intended for this eye and that the first eye is located in the first half space and the second eye in the second half space.

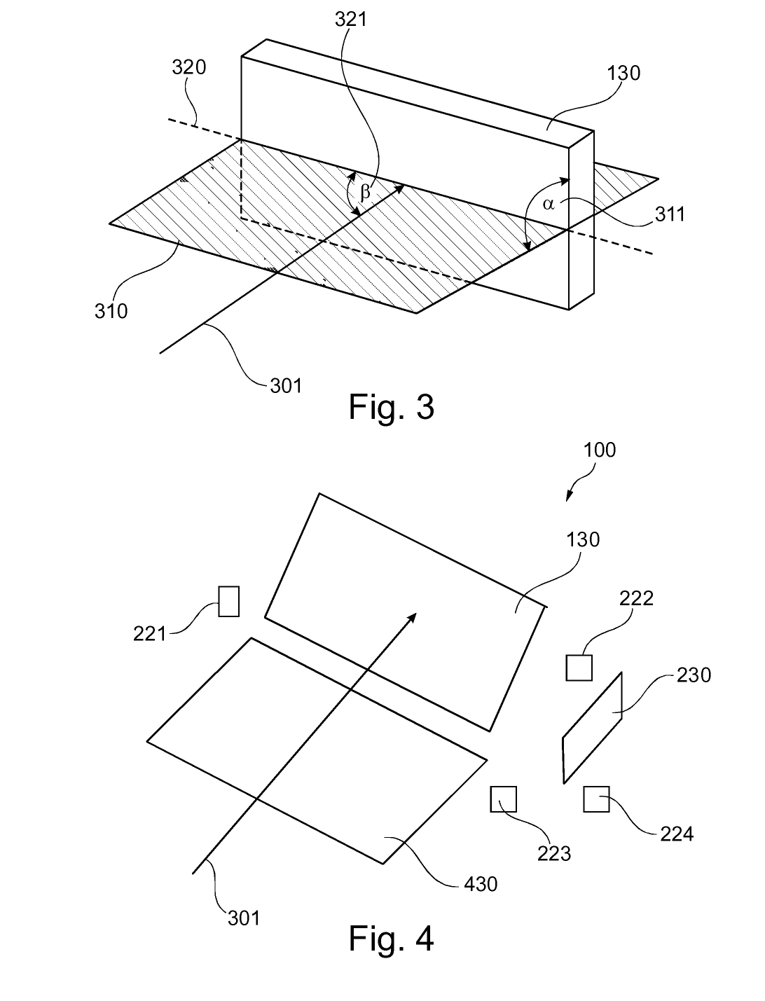

FIG. 3 shows a holographic display device 130 in an isometric illustration. A sagittal plane 310 is spanned by a viewing direction 301 of the user towards the display device 130 and a horizontal axis 320 of the display device 130.

The sagittal plane 310 therefore intersects the display device 130 at an angle α 311. The angle β 321 is spanned by the viewing direction 301 in the sagittal plane 310 and the display device 130.

A change in the angle α 311 corresponds to a vertical movement of the user in front of the display device 130.

A horizontal movement of the user in front of the display device 130 causes at least one eye to leave the half space intended for this eye and therefore to perceive either the wrong image or no image at all, thus disrupting the impression of a three-dimensional scenario. In order to maintain the impression of a three-dimensional scenario regardless of a movement of the user, the holographic display device 130 is moved by the actuator 202 so that the angle β 321 constantly retains a specified or determined value.

FIG. 4 shows a display apparatus 100 according to a further exemplary embodiment of the invention. The display apparatus has a holographic display device 130, a two-dimensional display element 430, a second holographic display device 230 and four cameras 221, 222, 223, 224 which constitute the detector unit for the position of the user's eyes and/or the user's finger.

The cameras can be designed to determine a positioning of the finger on the display device, and also to determine a positioning of the finger in space.

Both the first display device 130 and the second display device 230 can be rotated by an actuator (not shown) about their respective vertical axis such that a viewing angle 301 falls on the display device 130 and the display device 230 at a constant specifiable or specified angle.

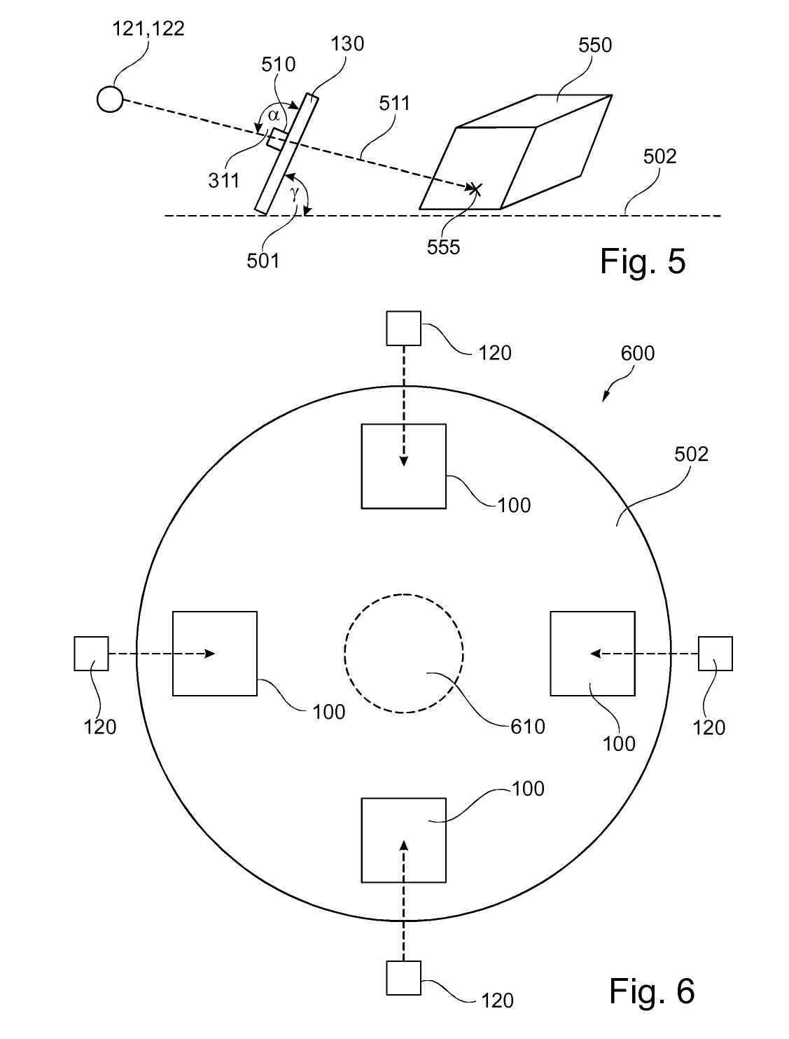

FIG. 5 shows a side view of a holographic display device 130 and a schematically shown three-dimensional scenario 550. The display device 130 is designed to depict a pointer element 510.

To enable the user to interact with a three-dimensional scenario, the pointer element 510 can be moved on the display device 130. This can be carried out, for example, by touching the display device 130 with a finger or, for example, by moving or actuating an input element, such as a so-called computer mouse for example.

To detect the selected region 555 in the three-dimensional scenario, a connecting line 511 is formed from the eye 121, 122 of the user via the pointer element 510 to the three-dimensional scenario 550. The element 555 selected by the user in the three-dimensional scenario can be determined based on the connecting line 511.

The selected element 555 can be a single object or a part of an object in the three-dimensional scenario. For example, a vehicle, such as an aircraft, or any part of the vehicle, for example a wing or rudder, can be selected.

The connecting line 511 corresponds to the viewing direction 301 of the user towards the display unit 130, whereby the connecting line 511 and the display device 130 include the angle α 311. As already shown, a change in the angle α does not affect the impression of the perception of a three-dimensional scenario by the user. A change in the angle γ 501 between the display device 130 and a horizontal line 502, for example the surface of a table, also has no effect on the three-dimensional perception by the user.

FIG. 6 shows a depiction apparatus 600 for a three-dimensional scenario for cooperative processing of the two-dimensional scenario by a plurality of users according to an exemplary embodiment of the invention. Four display apparatuses 100 are arranged at a workstation, for example a table 502. Here, each display apparatus is assigned to one user 120.

Each user 120 views the display apparatus 100 assigned to him so that the impression of a three-dimensional scenario is evoked for each user. From the point of view of the users 120, the situation is such that the users observe a virtual three-dimensional overall scenario 610.

It must be pointed out that the virtual three-dimensional overall scenario is only visible when the users observe the display apparatus 100 assigned to them or any display apparatus 100.

The display apparatus shown in FIG. 6 therefore enables joint cooperative processing of a three-dimensional overall scenario by a plurality of users, wherein the processing of the three-dimensional scenario can be facilitated in that direct communication and agreement between one another is made possible for the users.

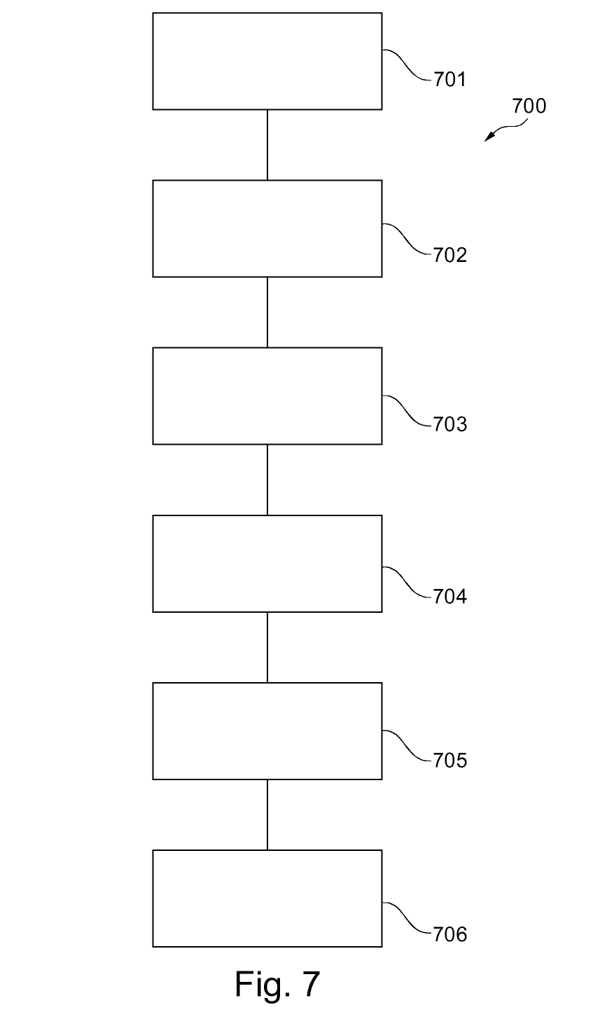

FIG. 7 shows a method 700 for the depiction and cooperative processing of a three-dimensional overall scenario according to an exemplary embodiment of the invention.

Here, in a first step 701, a first image and a second image are projected onto one holographic display device of a multiplicity of holographic display devices so that an observer of the three-dimensional display apparatus has the impression of a three-dimensional scenario, wherein each holographic display device depicts the three-dimensional overall scenario from a certain viewing perspective.

In doing so, the first image and the second image are projected from a first projection device and a second projection device respectively onto one holographic display device. Projecting a multiplicity of first images and second images onto one display device of a multiplicity of holographic display devices makes it possible for a multiplicity of operators to observe the three-dimensional scenario from their own perspective in each case.

Accordingly, the viewing perspective of the user of the three-dimensional scenario is in each case made up of a pair of a first image and a second image which are projected onto the display device assigned to this user.

The provision of the first image and the second image for the multiplicity of display apparatuses can be controlled, for example, by a central control system or central computer system. The central control system can be designed to provide the various image perspectives of a user described above and in the following of the three-dimensional overall scenario.

In doing so, each holographic display device can depict the three-dimensional overall scenario from a particular viewing perspective described above.

For example, the three-dimensional overall scenario can be depicted such that a plurality of display devices arranged at a workstation depict the three-dimensional overall scenario from a so-called natural perspective.

In this way, for example, four display devices can be arranged at a workstation such that a first display device shows the three-dimensional overall scenario from a first perspective, for example from an easterly direction, a second display device shows it from a second perspective, for example from a southerly direction, a third display device shows it from a third perspective, for example a westerly direction, and a fourth display device shows it from a fourth perspective, for example a northerly direction.

Here, the viewing perspectives of the users can correspond to those perspectives which the users would have of a miniature portrayal of the three-dimensional overall scenario if this miniature portrayal were actually located between the users in the middle of the workstation.

Of course, each display device can show any perspective of the three-dimensional overall scenario.

In a second step 702, an eye position of the observer is detected.

Here, for example, the position of only one eye, for example the left eye or the right eye, can be detected and a conclusion drawn regarding the position of the user's right eye or left eye respectively. However, the position of the user's right eye and left eye can be detected in order to take into account the individual horizontal interpupillary distance of different users.

Likewise, the central control system can have a user identification system, by means of which, after detecting a first eye position, the position of the second eye can be determined from the individual horizontal interpupillary distance which is known to the central control system.

The eye position can be detected by means of a detector unit, for example one or a multiplicity of cameras. In this case, the eye position can be detected by means of image recognition. Likewise, the eye position can be detected by attaching a marker at a certain distance and angle from one eye, for example to the user's forehead. By detecting the position of the marker, the central control system determines the position of one eye or both eyes of the user.

In a third step 703, the holographic display apparatus is rotated about a vertical axis such that a view direction of the observer falls on the holographic display apparatus at a specified angle in a sagittal plane of the display apparatus.

This guarantees that a first eye of the user always perceives the first image and a second eye always perceives a second image that are projected onto the holographic display device such that the user has the impression of a three-dimensional overall scenario.

In particular, rotating the display device avoids one eye of the user not perceiving an image or both eyes perceiving the same image, which would disrupt the three-dimensional impression.

In other words, the rotation of the display device about a vertical axis is intended to compensate for a sideward movement of the user such that the first image and the second image each meet one eye in all cases. A vertical movement of the user is not suitable for disrupting the three-dimensional effect to the same extent as the sideward movement or horizontal movement, as the eyes are able to perceive different images regardless of the vertical position of the user due to the horizontal interpupillary distance of the user's eyes.

In a fourth step 704, a reference point on the holographic display device is defined.

Here, the reference point can be defined as a point on the holographic display device. This then involves a definition of a plane corresponding to the display device, that is to say a two-dimensional positioning. However, the reference point can also be defined as a point in space.

Here, a finger of the user, which defines the reference point by means of a touch-sensitive detection layer on the display device, can be used to define the reference point.

A position of the user's finger in space or on the display device can also be determined by means of a detection system. Here, the finger position can basically be determined using the same methods as the detection of the user's eye position described above.

The reference point can also be defined by moving a conventional graphical pointing device, for example a so-called computer mouse or trackball, which is connected to the central control system as an input device.

In a fifth step 705, a connecting line from the eye position via the reference point to the three-dimensional overall scenario is calculated.

The central control system knows the position of at least one eye of the user which serves as the first point of the connecting line. The reference point, which serves as the second point of the connecting line, is also known.

An object sighted by the observer in the three-dimensional overall scenario is then determined in a sixth step 706.

By interpolation, the connecting line is extended into the three-dimensional scenario and an object in this scenario which the user has sighted or selected, i.e. the object to which the user has pointed, is thus identified.

Any available actions can subsequently be applied to the selected object. Here, the central control system can be designed to offer the user a choice of actions from an overall set of actions, wherein the choice of actions has such actions which can be applied to the selected object in the current situation.

For example, the overall set of actions can have all actions for an unmanned aircraft, and the choice of actions can have only those actions which are permitted in a specific situation. For example, the instruction to reduce altitude can be inadmissible in such a case if the altitude would be less than the minimum altitude.

By this means, the apparatus according to the invention and/or the method according to the invention enable a cooperatively processable three-dimensional scenario to be controlled easily, quickly and intuitively by a plurality of users. In particular, the number of users can be any number, as the method according to the invention and the apparatus according to the invention can be scaled at will.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-12. (canceled)

13. A depiction apparatus for the cooperative processing of a virtual three-dimensional scenario by a plurality of users, comprising:
a plurality of display apparatuses configured to depict the virtual three-dimensional scenario,
wherein the plurality of display apparatuses are configured to depict the virtual three-dimensional scenario from different viewing perspectives;
wherein at least one display apparatus of the plurality of display apparatuses is assigned to a user;
wherein each display apparatus is configured to provide the assigned user with a viewing perspective of the virtual three-dimensional scenario corresponding to a position of the display apparatus with reference to the virtual three-dimensional scenario.

14. The depiction apparatus of claim 13, wherein each display apparatus of the plurality of display apparatuses comprises:
a first projection device and a second projection device; and
a holographic display device having a first holographic unit and a second holographic unit;
wherein the first projection device and the second projection device are configured to respectively cast a first image and a second image onto the holographic display device;
wherein the first holographic unit and the second holographic unit are configured to respectively spread the first image and the second image such that a first eye of a user perceives the first image and a second eye of the user perceives the second image such that the user has a three-dimensional view of the three-dimensional scenario.

15. The depiction apparatus of claim 13, wherein each display apparatus of the plurality of display apparatuses comprises:
a detector unit; and
an actuator,
wherein the detector unit is configured to determine a position of the first eye and the second eye of the user, and
wherein the actuator is configured to move the holographic display device such that a viewing direction of the user meets the display apparatus at right angles in a sagittal plane of the display apparatus.

16. The depiction apparatus of claim 15, wherein the detector unit has at least one camera.

17. The depiction apparatus of claim 14, wherein
the holographic display device is configured to depict a pointer element, and
a connecting line is formed from the first eye or the second eye of the user via the pointer element to the virtual three-dimensional scenario so that the user can interact with the virtual three-dimensional scenario.

18. The depiction apparatus of claim 17, wherein the depiction apparatus is configured so that when the user touches the display apparatus with a finger, a pointer element is placed on the holographic display device.

19. The depiction apparatus of claim 17, wherein the pointer element is placed on the holographic display device by the detector unit detecting a position of the user's finger.

20. The depiction apparatus of claim 14, wherein each display apparatus of the plurality of display apparatuses comprises a two-dimensional display element, which is configured to provide the user with information in graphical and written form.

21. The depiction apparatus of claim 13, wherein a second display apparatus is assigned to the user, wherein the second display apparatus is configured to depict a three-dimensional representation of a spatially remote communication partner.

22. The depiction apparatus of claim 13, wherein the depiction apparatus is configured for cooperative monitoring of airspaces.

23. A method for depicting a virtual three-dimensional scenario, comprising the steps:
projecting a first image and second image onto one holographic display apparatus of a plurality of holographic display apparatus, wherein the projection of the first and second images provides an observer of the first and second images with a view of a three-dimensional scenario, wherein each of the plurality of holographic display apparatus depict the virtual three-dimensional scenario from a different viewing perspective, wherein each of the different viewing perspectives of the virtual three-dimensional scenario is provided corresponding to a position of the holographic display apparatus with reference to the virtual three-dimensional scenario;
detecting an eye position of the observer with respect to the one of the holographic display apparatus; and
rotating the one of the of the holographic display apparatus about a vertical axis such that a view direction of the observer falls on the one of the holographic display apparatus at a specified angle in a sagittal plane.

24. The method of claim 23, further comprising the steps:
detecting an eye position of the observer of the virtual three-dimensional scenario;
defining a reference point on the one of the holographic display apparatus;
calculating a connecting line from the eye position via the reference point to the virtual three-dimensional scenario; and
determining an object sighted by the observer in the virtual three-dimensional scenario.
